(19) United States
(12) Patent Application Publication
(10) Pub. No.: US 2026/0160289 A1
(43) Pub. Date: Jun. 11, 2026

(54) TURNING FASTENING STRUCTURE

(71) Applicant: FIVETECH TECHNOLOGY INC., New Taipei City (TW)

(72) Inventors: TING-JUI WANG, New Taipei City (TW); TUNG-JUNG CHANG, New Taipei City (TW)

(73) Assignee: FIVETECH TECHNOLOGY INC., New Taipei City (TW)

(21) Appl. No.: 19/359,729

(22) Filed: Oct. 16, 2025

(30) Foreign Application Priority Data
Dec. 9, 2024 (TW) 113147631

(51) Int. Cl. F16B 21/04; F16B 5/02

(52) U.S. Cl. CPC F16B 21/04; F16B 5/02

(57) ABSTRACT

The present disclosure provides a turning fastening structure, including a body portion, an operating portion, and a fastening portion. The body portion is arranged on an object; the operating portion is movably assembled with the body portion; the fastening portion is movably arranged in the body portion and is assembled with the operating portion; and the operating portion is moved longitudinally and then is moved rotationally, to drive the fastening portion to be fastened to another object through the object or to drive the fastening portion to be unfastened from the another object. In this way, a force may be applied to the operating portion, to cause the fastening portion to perform fastening or unfastening, to complete rapid coupling and separation of at least two objects, so as to achieve an effect of repeated rapid coupling and separation.

### CROSS-REFERENCE TO RELATED APPLICATION

This non-provisional application claims priority under 35 U.S.C. § 119(a) on Patent Application No(s). 113147631 filed in Taiwan, R.O.C. on Dec. 9, 2024, the entire contents of which are hereby incorporated by reference.

### BACKGROUND OF THE INVENTION

### 1. Field of the Invention

The present disclosure relates to a turning fastening structure, and in particular, to a turning fastening structure capable of repeatedly and rapidly coupling and separating at least two objects.

### 2. Description of the Related Art

Generally, when at least objects are coupled, locking is usually performed by using a screw, couple the objects.

In the foregoing conventional fixing manner, although the at least objects may be fixed and coupled in a manner in which the objects are not easily separated, in addition to causing a case in which the objects are not easily assembled, the fixing and coupling manner of the screw further causes a case in which the at least objects are not easily disassembled.

In view of the foregoing conventional technology, the inventor develops a turning fastening structure, to make it simple in structure and easy to use, so as to effectively overcome the defect of the usage.

### BRIEF SUMMARY OF THE INVENTION

In a turning fastening structure of the present disclosure, a force may be applied to an operating portion to cause a fastening portion to perform fastening or unfastening, to complete rapid coupling and separation of at least two objects, so as to achieve an objective of repeated rapid coupling and separation.

To achieve the foregoing objective and other objectives, the present disclosure provides a turning fastening structure, including a body portion, an operating portion, and a fastening portion. The body portion is arranged on an object; the operating portion is movably assembled with the body portion; the fastening portion is movably arranged on the body portion and is assembled with the operating portion; and the operating portion is moved longitudinally and then is moved rotationally, to drive the fastening portion to be fastened to another object through the object or to drive the fastening portion to be unfastened from the another object.

Optionally, the body portion is provided with an assembling portion, and the body portion is assembled to the object by using the assembling portion.

Optionally, the body portion is provided with an anti-rotation portion, and the anti-rotation portion forms anti-rotation with the object.

Optionally, the body portion is provided with a first limiting portion and a second limiting portion. The operating portion is moved to the first limiting portion to drive the fastening portion to perform unfastening or fastening, and the operating portion is moved to the second limiting portion to drive the fastening portion to perform fastening or unfastening.

Optionally, the first limiting portion is located at a high position of the body portion, the second limiting portion is located at a low position of the body portion, and the first limiting portion and the second limiting portion are offset from each other or connected to each other.

Optionally, the operating portion is provided with an abutting portion. Longitudinal movement of the operating portion causes the abutting portion to leave the first limiting portion, and causes the operating portion to be moved rotationally to the second limiting portion, so that the operating portion drives the fastening portion to perform unfastening or fastening.

Optionally, the operating portion is provided with an abutting portion. Longitudinal movement of the operating portion causes the abutting portion to leave a first limiting portion of the body portion, and causes the abutting portion to be moved rotationally to a second limiting portion of the body portion, so that the operating portion drives the fastening portion to perform unfastening or fastening.

Optionally, the operating portion is provided with an abutting portion and an avoiding portion. The avoiding portion is communicatively provided on a side of the operating portion. The abutting portion is arranged on an inner side of the operating portion and corresponds to the avoiding portion. Longitudinal movement of the operating portion causes the abutting portion to leave a first limiting portion of the body portion, to cause the avoiding portion to correspond to the first limiting portion. The abutting portion is moved rotationally to a second limiting portion of the body portion, and the first limiting portion enters the avoiding portion, so that the operating portion drives the fastening portion to perform unfastening or fastening.

Optionally, the fastening portion includes a coupling member. The coupling member couples the operating portion and the fastening portion, so that the operating portion is moved longitudinally and then is moved rotationally, and the operating portion drives the fastening portion to be fastened to the another object or to be unfastened from the another object.

Optionally, the fastening portion includes a coupling member, a rod body, and a fastening body. The coupling member couples the operating portion and the rod body, and the fastening body is arranged on the rod body, and the operating portion cooperates with the coupling member to drive the rod body, so that the fastening body is fastened to the another object or is unfastened from the another object.

Optionally, the turning fastening structure further includes an elastic component. The elastic component is sleeved on the fastening portion, and two ends of the elastic component are respectively coupled to the body portion and the operating portion, so that after the operating portion is moved longitudinally, the operating portion is driven to be moved rotationally due to elasticity of the elastic component, to drive the fastening portion to perform fastening or unfastening. The elastic component is a torsion spring, the two ends of the elastic component are respectively arranged on or interfered with or inserted into the body portion and the operating portion, so that the operating portion is automatically rotated or automatically and reciprocally rotated, or is automatically rotated or automatically and reciprocally rotated at a first limiting portion, a second limiting portion, a third limiting portion, or a guide portion of the body portion, or automatically rotated or automatically and reciprocally rotated at an abutting portion of the operating portion. The two ends of the elastic component are respectively arranged on or interfered with or inserted into the body portion and the operating portion, so that the operating portion is elastically rotated or elastically and reciprocally rotated, or is elastically rotated or elastically and reciprocally rotated at a first limiting portion, a second limiting portion, a third limiting portion, or a guide portion of the body portion, or elastically rotated or elastically and reciprocally rotated at an abutting portion of the operating portion.

Optionally, the body portion is provided with a first limiting portion, a second limiting portion, and a third limiting portion. A guide portion is arranged among the first limiting portion, the second limiting portion, and the third limiting portion. The operating portion is provided with a stopping portion, and the stopping portion is limited by the first limiting portion and the third limiting portion, and is functioned as anti-rotation for the operating portion.

### BRIEF DESCRIPTION OF THE DRAWINGS

For ease of illustrating the technical solutions in an embodiment of the present invention or in a prior art, the drawings that are required to be used in the description of embodiments will be briefly introduced. It is obvious that the drawings in the following description are only some embodiments of the present invention, and for people skilled in the art, other drawings can be obtained from these drawings without expending creative labor.

FIG. 1 is a first schematic diagram of an external appearance according to a first embodiment of the present disclosure.

FIG. 2 is a second schematic diagram of an external appearance according to a first embodiment of the present disclosure.

FIG. 3 is an exploded schematic diagram according to a first embodiment of the present disclosure.

FIG. 4 is a schematic diagram of a cross-sectional state according to a first embodiment of the present disclosure.

FIG. 5 is a first schematic diagram of a use state according to a first embodiment of the present disclosure.

FIG. 6 is a second schematic diagram of a use state according to a first embodiment of the present disclosure.

FIG. 7 is a third schematic diagram of a use state according to a first embodiment of the present disclosure.

FIG. 8 is a fourth schematic diagram of a use state according to a first embodiment of the present disclosure.

FIG. 9 is a schematic diagram of an external appearance according to a second embodiment of the present disclosure.

FIG. 10 is a schematic diagram of an external appearance of a body portion according to a second embodiment of the present disclosure.

FIG. 11 is a schematic diagram of an external appearance of an operating portion according to a second embodiment of the present disclosure.

### DETAILED DESCRIPTION OF THE INVENTION

The following further describes, with reference to the accompanying drawings, a turning fastening structure in the embodiments of the present disclosure.

The foregoing and other technical content, features, and effects related to the present disclosure can be clearly presented below in detailed description with reference to preferred embodiments of the reference drawings. It should be noted that directional terms mentioned in the embodiments, such as "above", "below", "left", "right", "front", or "rear", refer to the directions in the accompanying drawings. Therefore, the used directional terms are used for description, but are not intended to limit the present disclosure. In addition, in the following embodiments, same or similar components use same or similar reference signs.

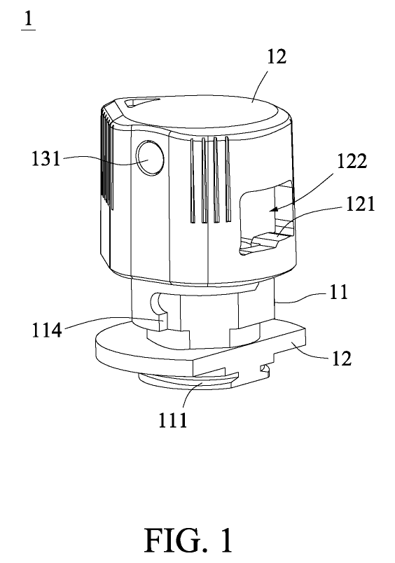

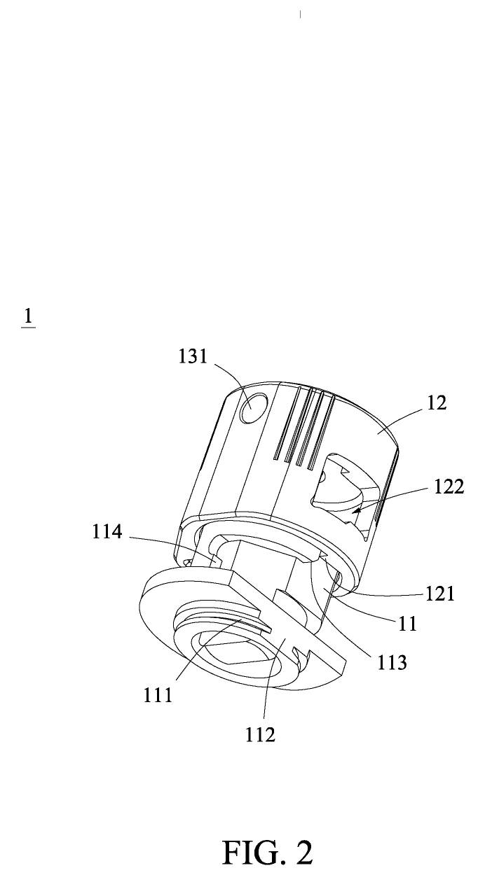

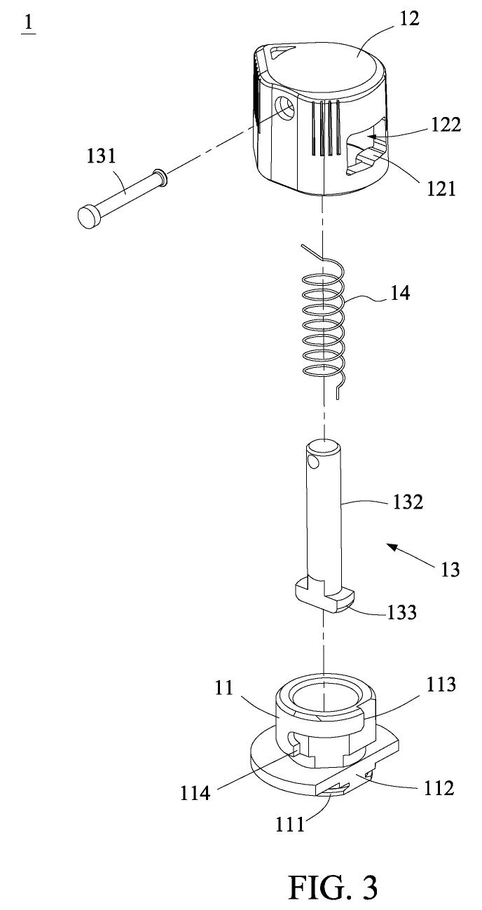

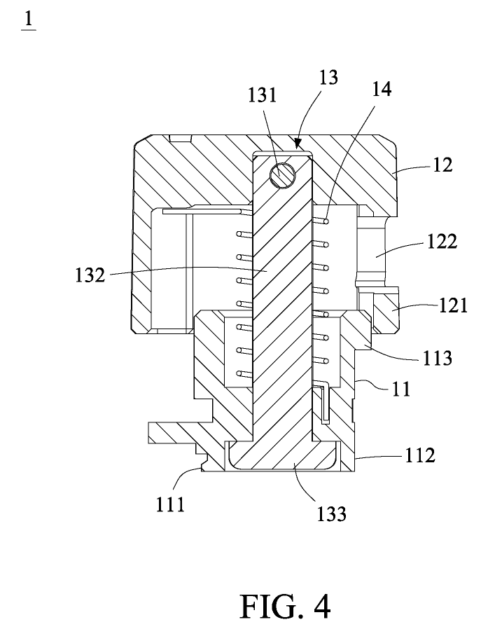

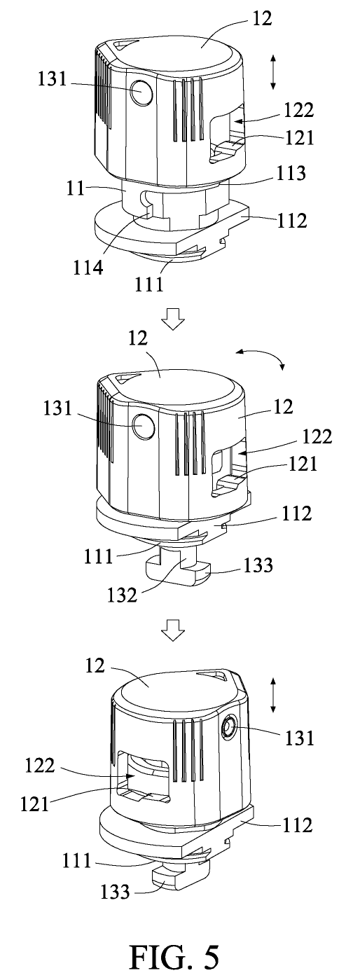

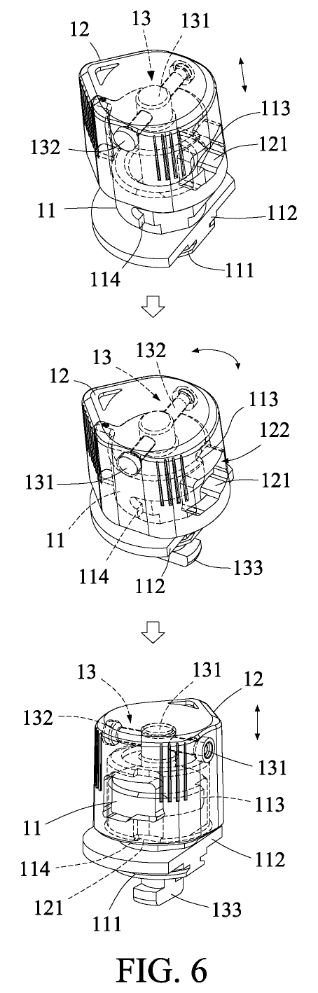

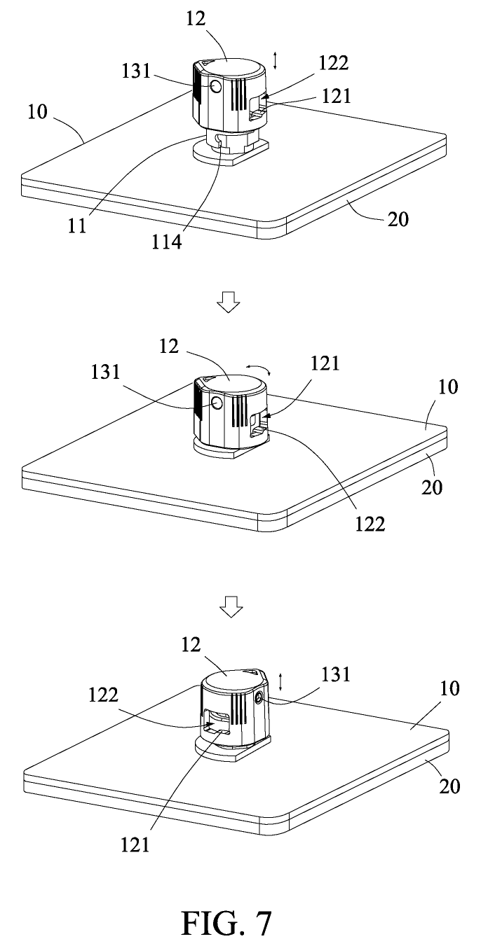

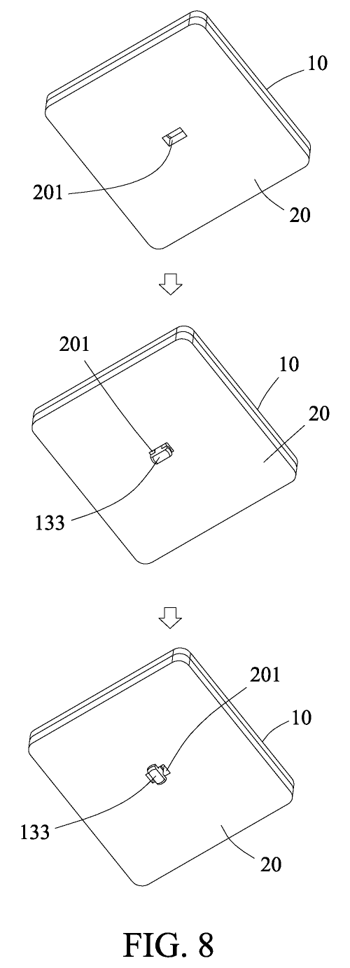

Referring to FIG. 1 to FIG. 8, as shown in the figures, the present disclosure provides a turning fastening structure. The turning fastening structure 1 includes a body portion 11, an operating portion 12, and a fastening portion 13.

The body portion 11 is arranged on an object 10.

The operating portion 12 is movably assembled with the body portion 11.

The fastening portion 13 is movably arranged in the body portion 11 and is assembled with the operating portion 12. The operating portion 12 is moved longitudinally and then is moved rotationally, to drive the fastening portion 13 to be fastened to another object 20 through the object 10 or to drive the fastening portion 13 to be unfastened from the another object 20.

During use, the body portion 11 of the turning fastening structure 1 may be assembled to the object 10. When the turning fastening structure 1 is used, a force may be first applied to the operating portion 12, to cause the operating portion 12 to be moved downward longitudinally, and then a rotational force is applied to cause the operating portion 12 to be moved rotationally, so that the operating portion 12 drives the fastening portion 13 to move due to movement, and the operating portion 12 drives the fastening portion 13 to be fastened to a fastened portion 201 of the another object 20 through the object 10.

In addition, a rotation force may also be applied to the operating portion 12 in a reverse direction, so that the operating portion 12 drives the fastening portion 13 to move in a rotating direction, and then the operating portion 12 is uploaded, so that the operating portion 12 drives the fastening portion 13 to move away from the fastened portion 201 of the another object 20 for unbuckling.

Based on the descriptions of the foregoing embodiments, in the turning fastening structure 1 of the present invention, the body portion 11 may be assembled to the object 10, and a force is applied to the operating portion 12, so that the fastening portion 13 is fastened or unfastened with the another object 20, to implement quick combination and separation of at least two objects, thereby achieving an objective of repeated quick combination and separation.

In an embodiment of the present invention, the body portion 11 is provided with an assembling portion 111. The body portion 11 is stably combined with the object 10 in a spreading, locking, or soldering manner by using the assembling portion 111, so that the operating portion 12 and the fastening portion 13 perform a required operation.

In an embodiment of the present disclosure, the body portion 11 is provided with an anti-rotation portion 112. The anti-rotation portion 112 forms anti-rotation with the object 10. The body portion 11 can be firmly assembled to the object 10 through cooperation between the assembling portion 111 and the anti-rotation portion 112, so that the operating portion 12 and the fastening portion 13 perform a required operation.

In an embodiment of the present disclosure, the body portion 11 is provided with a first limiting portion 113 and a second limiting portion 114. The first limiting portion 113 is located at a high position of the body portion 11, the second limiting portion 114 is located at a low position of the body portion 11, and the first limiting portion 113 and the second limiting portion 114 are offset from each other (or connected with each other). The operating portion 12 is moved to the first limiting portion 113 for limiting, to drive the fastening portion 13 to perform unfastening (or fastening), and the operating portion 12 is moved to the second limiting portion 114 for limiting, to drive the fastening portion 13 to perform fastening (or unfastening).

In an embodiment of the present disclosure, the operating portion 12 is provided with an abutting portion 121. Longitudinal movement of the operating portion 12 causes the abutting portion 121 to leave the first limiting portion 113, and causes the operating portion 12 to be moved rotationally to the second limiting portion 114, so that the operating portion 12 drives the fastening portion 13 to perform unfastening or fastening.

In an embodiment of the present disclosure, the operating portion 12 is provided with an abutting portion 121 and an avoiding portion 122. The avoiding portion 122 is communicatively provided on a side of the operating portion 12. The abutting portion 121 is arranged on an inner side of the operating portion 12 and corresponds to the avoiding portion 122. Longitudinal movement of the operating portion 12 causes the abutting portion 121 to leave a first limiting portion 113 of the body portion 11, to cause the avoiding portion 122 to correspond to the first limiting portion 113. The abutting portion is moved rotationally to a second limiting portion 114 of the body portion 11, and the first limiting portion 113 enters the avoiding portion 122, so that the operating portion 12 drives the fastening portion 13 to perform unfastening or fastening. In this way, the operating portion 12 can drive the fastening portion 13 to be fastened to or unfastened from the fastened portion 201, to complete rapid coupling and separation of at least two objects, so as to achieve an objective of repeated rapid coupling and separation.

In an embodiment of the present invention, the fastening portion 13 includes a coupling member 131. The coupling member 131 combines the operating portion 12 and the fastening portion 13, and the coupling member 131 may be bolted, fastened, locked, clamped, or wedged and combined to the operating portion 12, so that the operating portion 12 drives the fastening portion 13 to perform a needed movement by means of cooperation of the coupling member 131, and then moves the operating portion 12 in a longitudinal direction and then in a rotational direction, so that the operating portion 12 drives the fastening portion 13 to fasten a fastened portion 201 of another object 20 or to unfasten the fastening portion 13 from a fastened portion 201 of another object 20. In this way, the operating portion 12 drives the fastening portion 13 to be fastened or unfastened from the fastened portion 201, so as to implement quick combination and separation of at least two objects, thereby achieving an objective of repeated quick combination and separation.

In an embodiment of the present disclosure, the fastening portion 13 includes a coupling member 131, a rod body 132, and a fastening body 133. The coupling member 131 couples the operating portion 12 and the rod body 132, the fastening body 133 is arranged on the rod body 132, and the operating portion 12 cooperates with the coupling member 131 to drive the rod body 132, so that the rod body 132 drives the fastening body 133 to be fastened to the fastened portion 201 of the another object 20 or to be unfastened from the fastened portion 201 of the another object 20. In this way, the operating portion 12 can drive the fastening portion 13 to be fastened to or unfastened from the fastened portion 201, to complete rapid coupling and separation of at least two objects, so as to achieve an objective of repeated rapid coupling and separation.

In an embodiment of the present disclosure, the avoiding portion 122 may be a spatial region, a hole portion, a recess portion, a groove portion, or an open region; so that the avoiding portion 122 can meet different avoidance requirements.

In an embodiment of the present disclosure, the fastening body 133 may be an elastic fastening body, an external thread body, a column body, an internal thread body, an external fastening body, or an internal fastening body. In this way, the fastening body 133 can better meet an actual application requirement.

Based on the foregoing embodiments, during use of the turning fastening structure 1 of the present disclosure, the body portion 11 of the turning fastening structure 1 may be assembled to the object 10. When the turning fastening structure 1 is used, a force may be first applied to the operating portion 12, so that the operating portion 12 is moved downward longitudinally, to cause the abutting portion 121 to leave the first limiting portion 113, and cause the avoiding portion 122 to correspond to the first limiting portion 113. Then, a rotational force is applied, so that the operating portion 12 is moved rotationally, to cause the abutting portion 121 to be moved rotationally to the second limiting portion 114 of the body portion 11, and cause the first limiting portion 113 to enter the avoiding portion 122. In this way, the operating portion 12 drives the coupling member 131, the rod body 132, and the fastening body 133 to be moved downward at the same time due to movement, and the operating portion 12 drives the fastening body 133 of the fastening portion 13 to be fastened to the fastened portion 201 of the another object 20 through the object 10. In this way, the fastening portion 13 may be driven by the operating portion 12 to fasten the lock part 13 to the fastened portion 201, so as to implement quick combination of at least two objects.

In addition, a rotational force may also be applied to the operating portion 12 in a reverse direction, so that the abutting portion 121 of the operating portion 12 is moved in a rotating direction and leaves the second limiting portion 114, and the coupling member 131, the rod body 132, and the fastening body 133 are moved in a rotating direction at the same time, and the avoiding portion 122 corresponds to the first limiting portion 113. Then, the operating portion 12 is uploaded, so that the abutting portion 121 is moved in a longitudinal direction to abut against the first limiting portion 113, and the operating portion 12 is moved in an upward direction at the same time, and the fastening body 133 of the fastening portion 13 leaves the another object 20 for unbuckling. In this way, the operating portion 12 can drive the fastening portion 13 to be unfastened from the fastened portion 201, to complete rapid separation of at least two objects, so as to achieve an objective of repeated rapid coupling and separation.

In an embodiment of the present disclosure, the turning fastening structure 1 further includes an elastic component 14. The elastic component 14 may be a torsion spring. The elastic component 14 is sleeved on the rod body 132 of the fastening portion 13, and two ends of the elastic component 14 are respectively coupled to the body portion 11 and the operating portion 12. Therefore, after the operating portion 12 is moved longitudinally, the operating portion 12 is driven to be moved rotationally due to elasticity of the elastic component 14, so as to drive the fastening body 133 of the fastening portion 13 to perform fastening or unfastening.

Based on the foregoing embodiment, when the turning fastening structure 1 of the present invention is in use, the turning fastening structure 1 may be assembled to the object 10 by using the body portion 11. In this case, the elastic component 14 may be in an elastically contracted state. However, when the turning fastening structure 1 is used, a pressing force may be first applied to the operating portion 12, so that the operating portion 12 moves longitudinally downward, the abutting portion 121 leaves the first limiting portion 113, and the avoiding portion 122 corresponds to the first limiting portion 113. Then, the operating portion 12 automatically performs a rotational force due to elastic release of the elastic component 14, so that the operating portion 12 moves in a rotational direction, and the abutting portion 121 moves in a rotational direction to the second limiting portion 114 of the body portion 11 to form a stop. The first limiting portion 113 is made to enter the avoiding portion 122, so that the operating portion 12 moves to drive the coupling member 131, the rod body 132, and the fastening body 133 downward at the same time, and the operating portion 12 drives the fastening body 133 of the fastening portion 13 to be fastened to the fastened portion 201 of the another object 20 through the object 10. In this way, the fastening portion 13 may be driven by the operating portion 12 to fasten the lock part 13 to the fastened portion 201, so as to implement quick combination of at least two objects.

In addition, a rotational force may also be applied to the operating portion 12 in a reverse direction, so that the abutting portion 121 of the operating portion 12 is moved in a rotational direction and away from the second limiting portion 114, and the coupling member 131, the rod body 132, and the fastening body 133 are moved in a rotational direction at the same time, so that the elastic component 14 returns to the elastic contracted state, and the avoiding portion 122 corresponds to the first limiting portion 113. Then, the elastic component 14 automatically uploads the operating portion 12, so that the abutting portion 121 is moved longitudinally against the first limiting portion 113, so that the operating portion 12 is moved upward at the same time, and the fastening body 133 of the fastening portion 13 is released from the another object 20 to perform unbuckling. In this way, the operating portion 12 can drive the fastening portion 13 to be unfastened from the fastened portion 201, to complete rapid separation of at least two objects, so as to achieve an objective of repeated rapid coupling and separation.

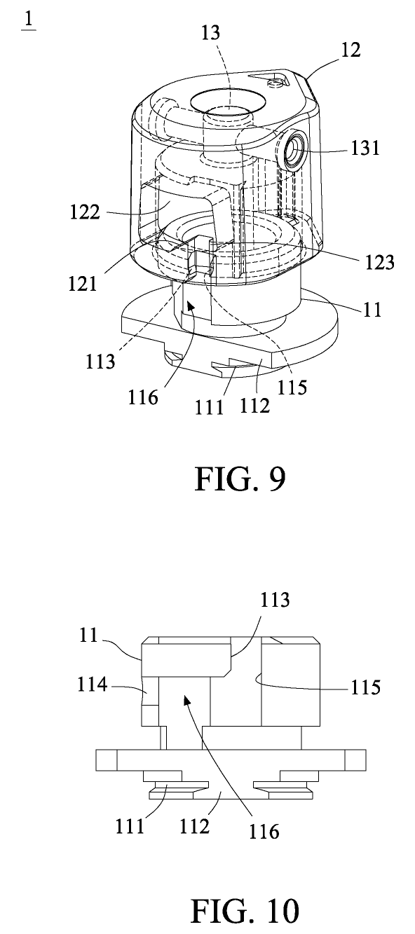

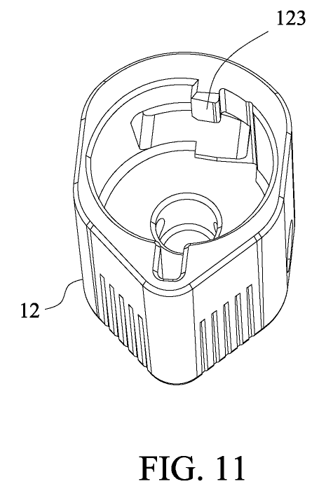

Referring to FIG. 9 to FIG. 11, as shown in the figures, in an embodiment of the present disclosure, the body portion 11 is provided with a first limiting portion 113, a second limiting portion 114, and a third limiting portion 115, and a guide portion 116 is arranged among the first limiting portion 113, the second limiting portion 114, and the third limiting portion 115. The operating portion 12 is provided with a stopping portion 123, and the stopping portion 123 is limited by the first limiting portion 113 and the third limiting portion 115, and is functioned as anti-rotation for the operating portion 12. The first limiting portion 113 and the third limiting portion 115 limit rotation of the stopping portion 123, so that an anti-rotation effect is achieved when the operating portion 12 is not used.

In an embodiment of the present disclosure, two ends of the elastic component 14 are respectively arranged on (interfered with or inserted into) the body portion 11 and the operating portion 12, so that the operating portion 12 is automatically rotated (or is automatically and reciprocally rotated) by using the elastic component 14, to cause the operating portion 12 to be automatically rotated (automatically and reciprocally rotated among the first limiting portion 113, the second limiting portion 114, the third limiting portion 115, and the guide portion 116 of the body portion 11 through cooperation of the abutting portion 121, so that the operating portion 12 is automatically rotated (or s automatically and reciprocally rotated).

In an embodiment of the present disclosure, two ends of the elastic component 14 are respectively arranged on (interfered with or inserted into) the body portion 11 and the operating portion 12, so that the operating portion 12 is elastically rotated or elastically and reciprocally rotated by using the elastic component 14, to cause the operating portion 12 to be elastically rotated (or elastically and reciprocally rotated) among the first limiting portion 113, the second limiting portion 114, the third limiting portion 115, and the guide portion 116 of the body portion 11 through cooperation of the abutting portion 121, so that the operating portion 12 is elastically rotated (or is elastically and reciprocally rotated).

Based on the foregoing embodiment, when the turning fastening structure 1 of the present invention is in use, the elastic component 14 may be in an elastic contracted state in advance, and the stopping portion 123 forms a limit between the first limiting portion 113 and the third limiting portion 115. However, when the turning fastening structure 1 is used, a pressing force may be first applied to the operating portion 12, to cause the operating portion 12 to move longitudinally downward, to cause the abutting portion 121 and the stopping portion 123 to leave the first limiting portion 113, and the avoiding portion 122 to correspond to the first limiting portion 113. Then, the operating portion 12 automatically applies a rotational force due to elastic release of the elastic component 14, to cause the operating portion 12 to move in a rotational direction. The abutting portion 121 and the stopping portion 123 are simultaneously moved in a rotating direction through the guide portion 116, and the abutting portion 121 is moved to the second limiting portion 114 of the body portion 11 to form a stop, and the first limiting portion 113 is made to enter the avoiding portion 122, so that the coupling member 131, the rod body 132, and the fastening body 133 are simultaneously moved downward due to motion of the operating portion 12, and the operating portion 12 drives the fastening body 133 of the fastening portion 13 to be fastened to the fastened portion 201 of the another object 20 through the object 10. In this way, the fastening portion 13 may be driven by the operating portion 12 to fasten the lock part 13 to the fastened portion 201, so as to implement quick combination of at least two objects.

In addition, a rotational force may also be applied to the operating portion 12 in a reverse direction, so that the abutting portion 121 and the stopping portion 123 of the operating portion 12 move in a rotational direction, the abutting portion 121 leaves the second limiting portion 114, and the abutting portion 121 moves to the first limiting portion 113 at the guide portion 116, so that the coupling member 131, the rod body 132, and the fastening body 133 move in a rotational direction at the same time, the elastic component 14 returns to the elastic contracted state, and the avoiding portion 122 corresponds to the first limiting portion 113. Then, the elastic component 14 automatically uploads the operating portion 12, and the abutting portion 121 moves longitudinally against the first limiting portion 113. In addition, the stopping portion 123 is moved to a position between the first limiting portion 113 and the third limiting portion 115 to form a limit, so that the operating portion 12 is driven to move upward at the same time, and the fastening body 133 of the fastening portion 13 is moved away from the another object 20 for unbuckling. In this way, the fastening portion 13 and the fastened portion 201 can be unfastened by the operating portion 12, so as to complete the rapid separation of at least two objects and achieve the purpose of repeated rapid combination and separation.

In conclusion, according to the turning fastening structure of the present disclosure, a force may be applied to the operating portion, so that the fastening portion performs fastening or unfastening, to complete rapid coupling and separation of at least two objects, so as to achieve an objective of repeated rapid coupling and separation.

The foregoing descriptions are merely embodiments of the present disclosure, but are not intended to limit the patent scope of the present disclosure.

What is claimed is:

1. A turning fastening structure, comprising:
a body portion, configured to be arranged on an object;
an operating portion, movably assembled with the body portion; and
a fastening portion is actively disposed in the body portion and is combined or integrally formed with the operating portion, or the operating portion is moved longitudinally and then moved rotationally, or is used for driving the fastening portion to be fastened to another object or driving the fastening portion to be unfastened from another object.

2. The turning fastening structure according to claim 1, wherein an assembling portion is provided on the body portion, and the body portion is disposed on the object in a combined manner by using the assembling portion.

3. The turning fastening structure according to claim 1, wherein the body portion is provided with an anti-rotation portion, and the anti-rotation portion forms anti-rotation with the object.

4. The turning fastening structure according to claim 1, wherein the body portion is provided with a first limiting portion or a second limiting portion, the operating portion is moved to the first limiting portion to drive the fastening portion to perform unfastening or fastening, and the operating portion is moved to the second limiting portion to drive the fastening portion to perform fastening or unfastening.

5. The turning fastening structure according to claim 4, wherein the first limiting portion is located at a high position of the body portion, the second limiting portion is located at a low position of the body portion, and the first limiting portion and the second limiting portion are offset from each other or connected to each other.

6. The turning fastening structure according to claim 4, wherein the operating portion is provided with an abutting portion, and longitudinal movement of the operating portion causes the abutting portion to leave the first limiting portion, and causes the operating portion to be moved rotationally to the second limiting portion, so that the operating portion drives the fastening portion to perform unfastening or fastening.

7. The turning fastening structure according to claim 1, wherein the operating portion is provided with an abutting portion, and longitudinal movement of the operating portion causes the abutting portion to leave a first limiting portion of the body portion, and causes the abutting portion to be moved rotationally to a second limiting portion of the body portion, so that the operating portion drives the fastening portion to perform unfastening or fastening.

8. The turning fastening structure according to claim 1, wherein the operating portion is provided with an abutting portion and an avoiding portion, the avoiding portion is communicatively provided on a side of the operating portion, the abutting portion is arranged on an inner side of the operating portion and corresponds to the avoiding portion, longitudinal movement of the operating portion causes the abutting portion to leave a first limiting portion of the body portion, to cause the avoiding portion to correspond to the first limiting portion, and the abutting portion is moved rotationally to a second limiting portion of the body portion, and the first limiting portion enters the avoiding portion, so that the operating portion drives the fastening portion to perform unfastening or fastening.

9. The turning fastening structure according to claim 1, wherein the fastening portion comprises a coupling member, the coupling member couples the operating portion and the fastening portion, so that the operating portion is moved longitudinally and then is moved rotationally, and the operating portion drives the fastening portion to be fastened to the another object or to be unfastened from the another object.

10. The turning fastening structure according to claim 1, wherein the fastening portion comprises a coupling member, a rod body, or a fastening body, the coupling member couples the operating portion and the rod body, the fastening body is arranged on the rod body, and the operating portion cooperates with the coupling member to drive the rod body, so that the fastening body is fastened to the another object or unfastened from the another object.

11. The turning fastening structure according to claim 1, further comprising an elastic component, wherein the elastic component is sleeved on the fastening portion, two ends of the elastic component are respectively coupled to the body portion and the operating portion, the operating portion is moved longitudinally, and the operating portion is driven to be moved rotationally due to elasticity of the elastic component, to drive the fastening portion to perform fastening or unfastening; the elastic component is a torsion spring, and the two ends of the elastic component are respectively arranged on or interfered with or inserted into the body portion and the operating portion, to cause the operating portion to be automatically rotated or automatically and reciprocally rotated, cause the operating portion to be automatically rotated or automatically and reciprocally rotated at a first limiting portion, a second limiting portion, a third limiting portion, or a guide portion of the body portion, and cause the operating portion to be automatically rotated or automatically and reciprocally rotated at an abutting portion of the operating portion; and the two ends of the elastic component are respective arranged on or interfered with or inserted into the body portion and the operating portion, to cause the operating portion to be elastically rotated or elastically and reciprocally rotated, cause the operating portion to be elastically rotated or elastically and reciprocally rotated at the first limiting portion, the second limiting portion, the third limiting portion, or the guide portion of the body portion, and cause the operating portion to be elastically rotated or elastically and reciprocally rotated at the abutting portion of the operating portion.

12. The turning fastening structure according to claim 1, wherein the body portion is provided with a first limiting portion, a second limiting portion, and a third limiting portion, a guide portion is arranged among the first limiting portion, the second limiting portion, and the third limiting portion, the operating portion is provided with a stopping portion, and the stopping portion is limited by the first limiting portion and the third limiting portion, and is functioned as anti-rotation for the operating portion.
